(19) United States
(12) Patent Application Publication
(10) Pub. No.: US 2016/0189268 A1
(43) Pub. Date: Jun. 30, 2016

(54) WEARABLE DEVICE FOR INTERACTING WITH MEDIA-INTEGRATED VENDORS

(71) Applicant: Saumil Ashvin Gandhi, Sunnyvale, CA (US)

(72) Inventor: Saumil Ashvin Gandhi, Sunnyvale, CA (US)

(21) Appl. No.: 14/587,673

(22) Filed: Dec. 31, 2014

(51) Int. Cl. G06Q 30/06; G02B 27/01; H04N 13/04

(52) U.S. Cl. CPC G06Q 30/0623; H04N 13/0429; G02B 27/017; G02B 2027/0178

(57) ABSTRACT

A wearable display device receives an image from a visual media being viewed through a lens of the display device and also receives an indication of at least one designated interaction location in the image. In response to a user input, interface objects are displayed on the lens so that the user sees them overlaid at one of the at least one interaction locations. The user then selects an interface object representing a type of product and an image associated with a vendor of the product type is displayed so that the user sees it overlaid at one of the at least one interaction locations. In response to a user input, a plurality of vendor interface objects associated with the vendor are displayed and the user selects a vendor interface object representing a specific product sold by the vendor. Additional information or options regarding the specific product are then displayed.

### FIELD

The present disclosure relates generally to image processing, and in a specific example embodiment, to user interactions with the visualization of a vendor, including associated items for sale, in a 3D (three-dimensional) media environment that enhances the illusion of depth perception using special projection hardware and/or eyewear.

### BACKGROUND

Conventionally, when an individual consumes media (e.g., in a theater) the experience is orchestrated ahead of time. For example, ads may be shown prior to the beginning of a movie in a theater environment. However, an individual movie-goer may desire information regarding what beverages are available in the lobby midway through the movie. Furthermore, providing simple text information (e.g., a menu) regarding available beverages may not be sufficient to entice the movie-goer to purchase one of the available beverages. In some cases, the individual movie-goer may not even consider making a purchase simply based on a lack of “on-demand” access to information regarding any items available for purchase in the locality of the theater environment.

### BRIEF DESCRIPTION OF DRAWINGS

Various ones of the appended drawings merely illustrate example embodiments of the present invention and cannot be considered as limiting its scope.

FIG. 1 is a block diagram illustrating an example embodiment of a network architecture of a system for using wearable display devices to interact with vendors integrated into a media environment.

FIG. 2 is a block diagram illustrating an example embodiment of a publication system.

FIG. 3 is a block diagram illustrating an example embodiment of a vendor interface engine.

FIG. 4 is a flow diagram of an example high-level method for using wearable display devices to interact with vendors integrated into a media environment.

FIG. 5 is a flow diagram of an example high-level method for displaying an image of a vendor integrated into a media environment.

FIG. 6A is a screenshot of an example media environment image with an interface displaying item types for selection.

FIG. 6B is a screenshot of the environment image with an image of a vendor of the selected item type integrated into the media environment.

FIG. 6C is a screenshot of an example pop-up window for displaying shopping information for items sold by the vendor associated with the vendor image.

FIG. 6D is a screenshot displaying an example pop-up window for displaying additional information regarding a selected one of the items sold by the vendor.

FIG. 6E is a screenshot displaying an example pop-up window for displaying recommendations.

FIG. 7 is a simplified block diagram of a machine in an example form of a computing system within which a set of instructions for causing the machine to perform any one or more of the methodologies discussed herein may be executed.

FIG. 8 is a simplified block diagram of a mobile device for use with any one or more of the methodologies discussed herein.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

As used herein, the term “or” may be construed in either an inclusive or exclusive sense. Additionally, although various example embodiments discussed below focus on a marketplace environment, the embodiments are given merely for clarity in disclosure. Thus, any type of electronic publication, electronic commerce, social networking, or electronic business system and method, including various system architectures, may employ various embodiments of the system and method described herein and may be considered as being within a scope of example embodiments. Each of a variety of example embodiments is discussed in detail below.

Example embodiments described herein provide systems and methods for interacting with vendors in a media viewing environment (e.g. a theater) using “smart” glasses. Smart glasses or Digital Eye Glasses or Personal Imaging Systems are wearable processing devices that display viewable images in addition to those available by simply viewing an environment. Standard ways for displaying the additional images include an optical head-mounted display (OHMD) or computerized internet-connected glasses with transparent heads-up display (HUD) or augmented reality (AR) overlay for displaying the images as well as allowing a user to see normally (e.g., consume visual media) through the lenses of the glasses.

In example embodiments, visual media (e.g., movies, television, etc.) may include an indicated locations for displaying (e.g., overlaying) images on specific images comprising the visual media. These locations may be chosen by the producers of the visual media before it produced for the purpose of allowing information, user interfaces or advertisements to be displayed seamlessly within the visual media. For example in an area of a movie image where nothing significant is occurring. This may often be along the top, bottom and sides of an image since the most important elements of an image are usually at the center of focus. These locations may also be chosen after a visual media is produced by performing a visual study of the media to determine the best locations for overlaying other images in a non-obtrusive fashion. The information may be transmitted to consumers of the visual media via a visual code embedded in the larger image. The code could be too small to see but the information regarding these locations could be available to a viewer of such visual media through a wearable display device (e.g., a pair of smart glasses) that capture an image with a camera from the visual media, analyze the image, and then detect and read the code to discover the indicated locations for overlaying images. Alternatively, if the wearable display device is capable of a network connection (e.g., to a provider of the visual media) then the information regarding the indicated locations for overlaying images could be received separately from the image and synchronized with images of the visual media.

In an embodiment, if a user of smart 3D glasses to view 3D visual media (e.g., being worn by an audience member (user) in a movie theater) so desires (e.g., via a selection) an interface displaying a plurality of item types for which vendors are available (e.g., in the lobby of the theater) are displayed at an indicated interface location in the image of the 3D visual media. In example embodiments, a user of the smart 3D glasses selects, using a shopping button of the 3-D glasses, one of the item types that the user is considering for purchase. A 3D image of a vendor is displayed at one of the indicated locations integrated with the image of the 3D media visual media on which it is overlaid. In example embodiments, the size of the 3D image of the vendor is scaled based on dimensional information (e.g., how far away the image is from the user) extracted from images of the visual media captured by a camera of the smart 3D glasses or based on information regarding where the user is sitting in the theater received over a network connection.

By using embodiments of the present invention, a user may select to view the merchandise associated with the 3D image of the vendor wherein the additional information includes shopping information, item description information, links to shopping sites, links to item listings, shipping information, pricing information, and item recommendation information. This may have the technical effect of increasing sales of products associated with the vendors for which 3D images have been integrated into the 3D media environment by allowing the vendors to entice the captive audience with sights (and even sounds if the smart 3D glasses include headphones) at any moment. This allows the movie-goer to view adds when they are most effective, i.e., when the movie-goer is interested in viewing them.

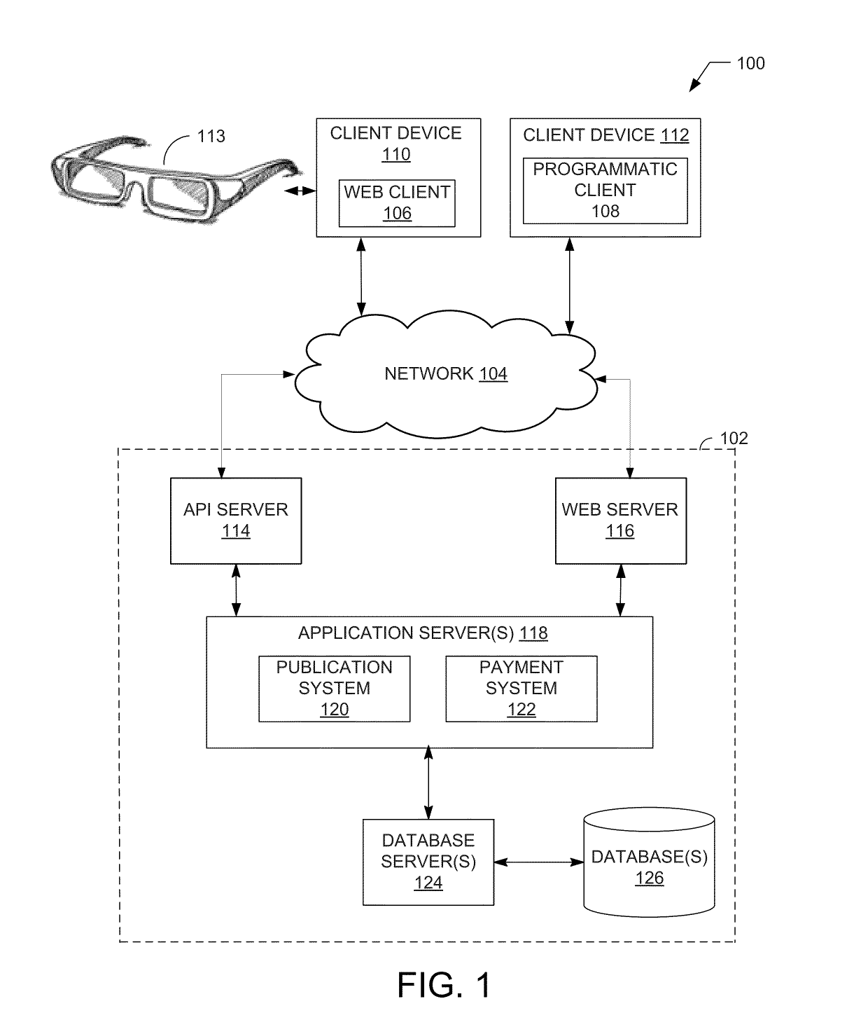

With reference to FIG. 1, an example embodiment of high-level client-server-based network architecture 100 to enable display of images in an environment using augmented reality is shown. A networked system 102, in an example form of a network-server-side functionality, is coupled via a communication network 104 (e.g., the Internet, wireless network, cellular network, or a Wide Area Network (WAN)) to one or more client devices 110 and 112. FIG. 1 illustrates, for example, a web client 106 operating via a browser (e.g., such as the INTERNET EXPLORER® browser developed by Microsoft® Corporation of Redmond, Wash. State), and a programmatic client 108 executing on respective client devices 110 and 112.

The client devices 110 and 112 may comprise a mobile phone, desktop computer, laptop, or any other communication device that a user may utilize to access the networked system 102. In embodiments, the client device 110 may comprise or be connectable to a wearable display device 113, e.g., in the form of a pair of glasses for enhancing the illusion of depth perception in visual media. In further embodiments, the client device 110 may comprise one or more of a camera, projector, touch screen, accelerometer, microphone, and GPS device. The client devices 110 and 112 may each be a device of an individual user interested in visualizing a vendor or a specific item sold by the vendor while viewing a visual media.

An Application Program Interface (API) server 114 and a web server 116 are coupled to, and provide programmatic and web interfaces respectively to, one or more application servers 118. The application servers 118 host a publication system 120 and a payment system 122, each of which may comprise one or more modules, applications, or engines, and each of which may be embodied as hardware, software, firmware, or any combination thereof. The application servers 118 are, in turn, coupled to one or more database servers 124 facilitating access to one or more information storage repositories or database(s) 126. The databases 126 may also store user account information of the networked system 102 in accordance with example embodiments.

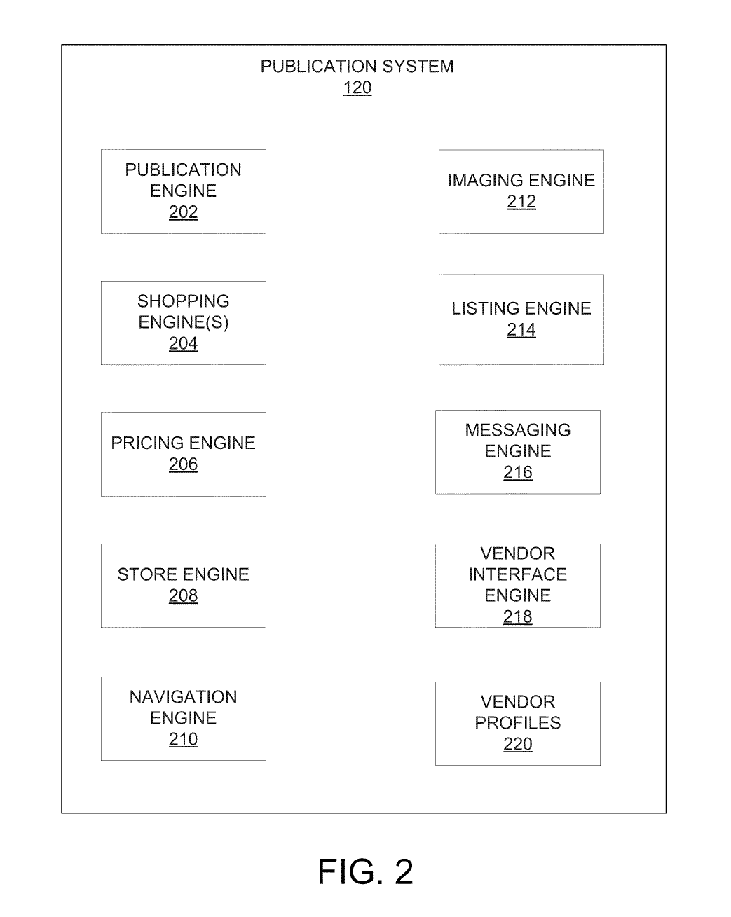

In example embodiments, the publication system 120 publishes content on a network (e.g., Internet). As such, the publication system 120 provides a number of publication functions and services to users that access the networked system 102. The publication system 120 is discussed in more detail in connection with FIG. 2. In example embodiments, the publication system 120 is discussed in terms of a marketplace environment. However, it is noted that the publication system 120 may be associated with a non-marketplace environment such as an informational or social networking environment. Furthermore, in the context of the present disclosure the publication system 120 may provide images and information regarding vendors and their merchandise to client devices 110 and 112 via the wearable display device 113.

The payment system 122 provides a number of payment services and functions to users. The payment system 122 allows users to accumulate value (e.g., in a commercial currency, such as the U.S. dollar, or a proprietary currency, such as “points”) in their accounts, and then later to redeem the accumulated value for products (e.g., goods or services) that are made available via the publication system 120 or elsewhere on the network 104. The payment system 122 also facilitates payments from a payment mechanism (e.g., a bank account, PayPal™, or credit card) for purchases of items via any type and form of a network-based marketplace. For example, in the context of the present disclosure the payment system 122 may facilitate payment to vendors via the wearable display device 113.

While the publication system 120 and the payment system 122 are shown in FIG. 1 to both form part of the networked system 102, it will be appreciated that, in alternative embodiments, the payment system 122 may form part of a payment service that is separate and distinct from the networked system 102. Additionally, while the example network architecture 100 of FIG. 1 employs client-server architecture, a skilled artisan will recognize that the present disclosure is not limited to such architecture. The example network architecture 100 can equally well find application in, for example, a distributed or peer-to-peer architecture system. The publication system 120 and payment system 122 may also be implemented as standalone systems or standalone software programs operating under separate hardware platforms, which do not necessarily have networking capabilities.

Referring now to FIG. 2, an example block diagram illustrating multiple components that, in one embodiment, are provided within the publication system 120 of the networked system 102 is shown. In one embodiment, the publication system 120 is a marketplace system where items may be offered for sale, e.g., via wearable display device 113. The publication system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more databases 126 via the one or more database servers 124.

In one embodiment, the publication system 120 provides a number of publishing, listing, and price-setting mechanisms whereby a seller may list (or publish information concerning) goods or services for sale (e.g., provide images and information that may be overlaid on visual media), a buyer can express interest in or indicate a desire to purchase such goods or services (e.g., via a selection made using wearable display device 113), and a price can be set for a transaction pertaining to the goods or services. To this end, the publication system 120 may comprise at least one publication engine 202 and one or more shopping engines 204.

A pricing engine 206 supports various price listing formats such as a fixed-price listing format (e.g., the traditional classified advertisement-type listing or a catalog listing). A store engine 208 allows a seller (e.g., vendor) to group listings within a “virtual” store, which may be branded and otherwise personalized by and for the seller for presentation to a viewer via the display device 113. Such a virtual store may also offer promotions, incentives, and features that are specific and personalized to the seller.

Navigation of the publication system 120 may be facilitated by a navigation engine 210. For example, a search module (not shown) of the navigation engine 210 enables, for example, keyword searches of vendors, listings or other information published via the publication system 120. In a further example, a browse module (not shown) of the navigation engine 210 allows users to browse various category, catalog, or data structures according to which listings or other information may be classified within the publication system 120. Various other navigation applications within the navigation engine 210 may be provided to supplement the searching and browsing applications. In one embodiment, the navigation engine 210 allows the user to search or browse for items in the publication system 120 (e.g., virtual stores, listings in a fixed-price or auction selling environment, listings in a social network or information system). In alternative embodiments, the navigation engine 210 may navigate (e.g., conduct a search on) a network at large (e.g., network 104). Based on a result of the navigation engine 210, the user may select an item that the user is interested in visualizing together with visual media currently being viewed by the user.

In order to make listings or posting of information available via the networked system 102 as visually informing and attractive as possible, the publication system 120 may include an imaging engine 212 that enables users to upload images, including 3D images, for inclusion within listings and to incorporate images within viewed listings. In some embodiments, the imaging engine 212 also receives image data from vendors and utilizes the image data to generate respective vendor interfaces for user interaction. For example, the imaging engine 212 may receive an image (e.g., still image, video) from a 3D visual media (e.g., via wearable display device 113) within which a user wants to browse items of a certain type for purchase. Furthermore, the imaging engine 212 may receive a 3D vendor image (e.g., still image, video) and other vendor data from the vendor profiles 220, which may also be stored in database(s) 126. The imaging engine 212 may work in conjunction with the vendor interface engine 218 to generate a 3D vendor interface for integration within the 3D visual media as will be discussed in more detail below.

A listing engine 214 manages listings on the publication system 120. In example embodiments, the listing engine 214 allows users to author listings of items. The listing may comprise an image (e.g., 3D) of an item along with a description of the item. In one embodiment, the listings pertain to goods or services that a user (e.g., a vendor) wishes to transact via the publication system 120. As such, the listing may comprise an image of a good for sale and a description of the item such as, for example, dimensions, color, and, identifier (e.g., UPC code, ISBN code). In some embodiments, a user may create a listing that is an advertisement or other form of publication to the networked system 102. The listing engine 214 also allows the users to manage such listings by providing various management features (e.g., auto-relisting, inventory level monitors, etc.).

A messaging engine 216 is responsible for the generation and delivery of messages to users of the networked system 102. Such messages include, for example, advising users regarding the status of listings and purchases (e.g., providing an acceptance notice to a buyer) or providing recommendations. Such messages may also include, for example, advising a vendor of a sale (e.g., sale of popcorn in a 3D movie) to a user of wearable display devices 113 and also advising of the location (e.g., theater seat no.) of the user so that the popcorn may be delivered to the user. The messaging engine 216 may utilize any one of a number of message delivery networks and platforms to deliver messages to users. For example, the messaging engine 222 may deliver electronic mail (e-mail), an instant message (IM), a Short Message Service (SMS), text, facsimile, or voice (e.g., Voice over IP (VoIP)) messages via wired networks (e.g., the Internet), a Plain Old Telephone Service (POTS) network, or wireless networks (e.g., mobile, cellular, WiFi, WiMAX, etc.).

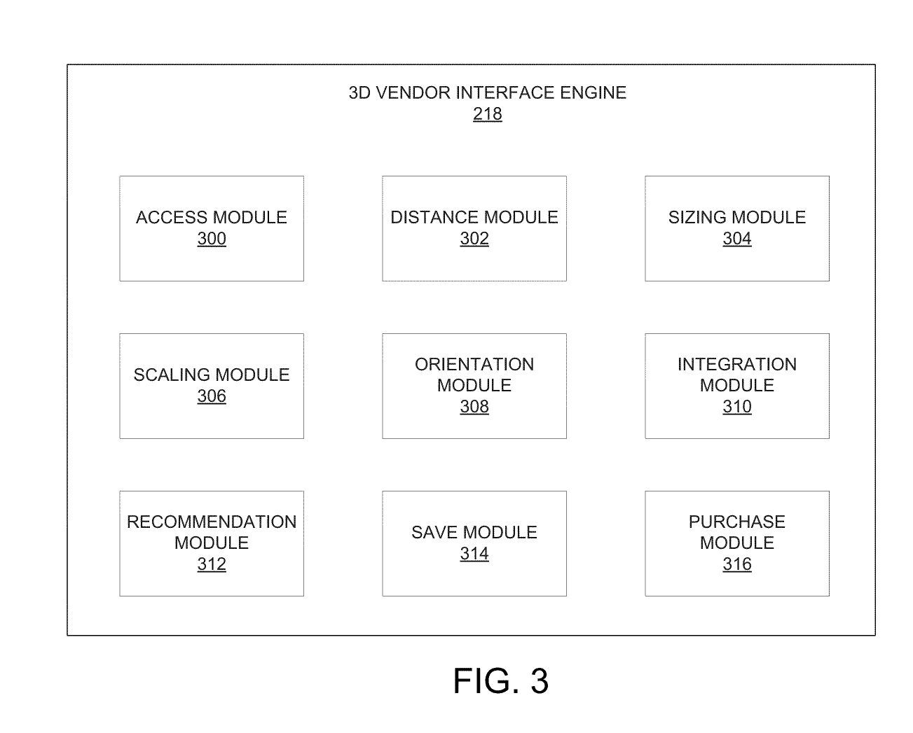

A vendor interface engine 218 manages the generation of a vendor interface for integration into a visual media based on an image from the visual media and product/item type specified by a user. The vendor interface engine 218 is shown as part of the publication system 120 but could be included in the wearable display device 113. The vendor interface engine 218 is discussed in more detail in connection with FIG. 3 below.

Although the various components of the publication system 120 have been defined in terms of a variety of individual modules and engines, a skilled artisan will recognize that many of the items can be combined or organized in other ways. Alternatively, not all components of the publication system 120 of FIG. 2 may be utilized. Furthermore, not all components of the marketplace system 120 have been included in FIG. 2. In general, components, protocols, structures, and techniques not directly related to functions of exemplary embodiments (e.g., dispute resolution engine, loyalty promotion engine, personalization engines, etc.) have not been shown or discussed in detail. The description given herein simply provides a variety of exemplary embodiments to aid the reader in an understanding of the systems and methods used herein.

FIG. 3 is a block diagram illustrating an example embodiment of the vendor interface engine 218. In example embodiments, the vendor interface engine 218 comprises an access module 300, a distance module 302, a sizing module 304, a scaling module 306, an orientation module 308, an integration module 310, a recommendation module 312, a save module 314, and a purchase module 316. In alternative embodiments, functions of one or more of the modules of the vendor interface engine 218 may be combined together, one or more of the modules may be removed from the vendor interface engine 218, or one or more of the modules may be located elsewhere in the networked system 102 (e.g., the imaging engine 214, shopping engines 204) or at the client device 110.

In example embodiments, the imaging engine 212 may receive an image from a visual media (e.g., still image, video) via client device 110/wearable display device 113. The image may then be provided to the vendor interface engine 218 for visual analysis. In some embodiments, the vendor interface engine 218 also receives information regarding the types of items that the user is interested in visualizing together with the visual media. The vendor interface engine 218 may then determine a location within the visual media image where an image associated with a vendor is to be integrated into the visual media. The image associated with the vendor may be received from the imaging engine 212 (or accessed directly from vendor profiles 220) based on a user selection of an item type using a search or browsing function of the navigation engine 210, for example, via access module 300 described below. The user may, in some cases, select attributes of the item to be browsed such as dimensions or a specific topping or flavor.

The access module 300 accesses item data for items of a user selected item type. In some embodiments, a vendor image to be integrated into the visual media may be selected by a user at the client device 110/wearable display device 113 and the selection may be received, for example, by the navigation engine 210 via access module 300. Based on the selection, the access module 300 may access information corresponding to the selection, e.g., from publication system 120 or database(s) 126. If the user then selects an item listing, from an inventory of vendor items accessible via interface options associated with the vendor image, the access module 300 may access the item listing (e.g., from publication system 120 or database(s) 126) and extract item data (e.g., dimensions, images) from the listing for display to the user. In other examples, if the selection is a user selected name or other item identifier of an item (e.g., UPC code), the access module 300 may access a catalog (e.g., stored in the database 126) that stores item data using the item identifier.

The distance module 302 determines a distance to a focal point in an image received from the visual media. The focal point may be an area (e.g., interface location) where an image is to be integrated into a visual media. For example, the dimensions of objects depicted in the image from the visual media may be analyzed to determine the distance between the wearable display device 113 and the visual media. In one embodiment, the distance module 302 may use a focus capability of wearable display device 113 (which may be coupled to client device 110) to determine the distance. As such, the distance module 302 may accurately determine the distance from a point of view of the user or image capture device (e.g., a camera of wearable display device 113) to the focal point for the purpose of integrating images smoothly into the visual media. In one embodiment, the distance module 302 may use data regarding a particular theater environment (e.g., data received via a network connection) to determine the distance.

The sizing module 304 determines relative sizing of images (e.g., to be overlaid) in relation to the dimensions of the visual media. In example embodiments, the sizing module 304 uses a marker (an object with known standard dimensions) in the visual media image to calculate the appropriate sizes of images to be integrated into the visual. For example, if a door is shown in the image, the sizing module 304 may assume that the door is a standard sized door (e.g., 36″×80″) or that a door knob is located at 36″ from the floor. Using these known standard dimensions, sizing for the visual media may be determined.

The scaling module 306 scales images to be integrated into the visual media based on the distance and sizing determined by the distance module 302 and the sizing module 304, respectively. Accordingly, the scaling module 306 may receive (e.g., from the navigation engine 210 via access module 300) or retrieve image data (e.g., from the database(s) 126) for vendors of items of a selected item type. The image data may include a vendor image, item images, dimensions, or item identifiers. If item image and dimensions are provided, then the scaling module 306 may use the item image and the dimensions to scale the image of the item to the visual media dimensions based on the sizing determined by the sizing module 304. Alternatively, if one of the image or dimension is not provided, the item identifier may be used to look up the item in an item catalog which may contain an image and item information for the item (e.g., dimensions and description). In one embodiment, the scaling module 306 may look up and retrieve the item information from the item catalog in the database(s) 126.

Once the item image is scaled, the scaled item image may be oriented to the user's environment by the orientation module 308. For example, if the image from the visual media includes a wall at a slight angle and a scaled item image is to be overlaid near the wall, the orientation module 308 orients the scaled item image to the angle of the wall. It is noted that functionality of any of the distance module 302, sizing module 304, scale module 306, and orientation module 308 may be combined into one or more modules that can determine proper sizing and orientation for the item image. In some embodiments, these combined modules may comprise or make use of one or more gyroscopes or accelerometers in the wearable display device 113 or the client device 110.

The integrating module 310 determines a location for the scaled and oriented item image to be integrated into the visual media image (based on the indicated locations for overlaid images and the distance, sizing, scaling and orienting data) to create a visual media-integrated vendor interface for interaction with a user viewing the visual media. The integrating module 310 then provides the image to be overlaid to the client device 110/wearable display device 113.

The recommendation module 312 optionally provides recommendations for alternative items (or types of items) for which vendors may be integrated into the visual media so that a user may browse the vendors merchandise for purchase. For example, if a user looks for a smaller sized item of a certain item type and is unable to find any, then (e.g., as determined by the navigation engine 210), the recommendation module 312 may suggest one or more alternative items that are smaller and may entice the user to make a purchase. Accordingly, the recommendation module 312 may determine dimensions that are more appropriate for the indicated item type and perform a search (e.g., provide instructions to the navigation engine 210 to perform a search) to find one or more alternative items, e.g., a smaller snack. The recommendation module 312 may then retrieve the vendor data for vendors of that type of item and provide the alternative vendors and/or specific items as a suggestion to the user.

The save module 314 saves visual media images for later use. In one embodiment, the visual media images may be stored to the database 126 of the networked environment 102. Alternatively, the visual media images may be stored to the client device 110/wearable display device 113. For example, the user may record the visual media and save the images therefrom. At a later time, the user may desire to view images integrated into a similar visual media image and the save module 314 may access and retrieve the saved visual media images including any dimensional information determined therefrom.

The purchase module 316 allows the user to purchase an item from a vendor for which a vendor interface has been integrated into the visual media or an alternative item recommended by the recommendation module 312. In one embodiment, the purchase module 316 provides a purchase interface option (e.g., button) on or near the vendor image that when used in regard to an item of the vendor takes the user to, for example, a purchase page for the item, a store front for a store of the vendor that sells the item, or search page with search results for availability of the item for purchase if no known vendor is available. In another embodiment, an activation of the purchase interface option may initiate an automatic purchase of the item. Once selected, the purchase module 316 performs the corresponding actions to facilitate the purchase (e.g., send a search for the item to the navigation engine 210, provide one or more listings using the shopping engine 204, provide a webpage associated with the store engine 208).

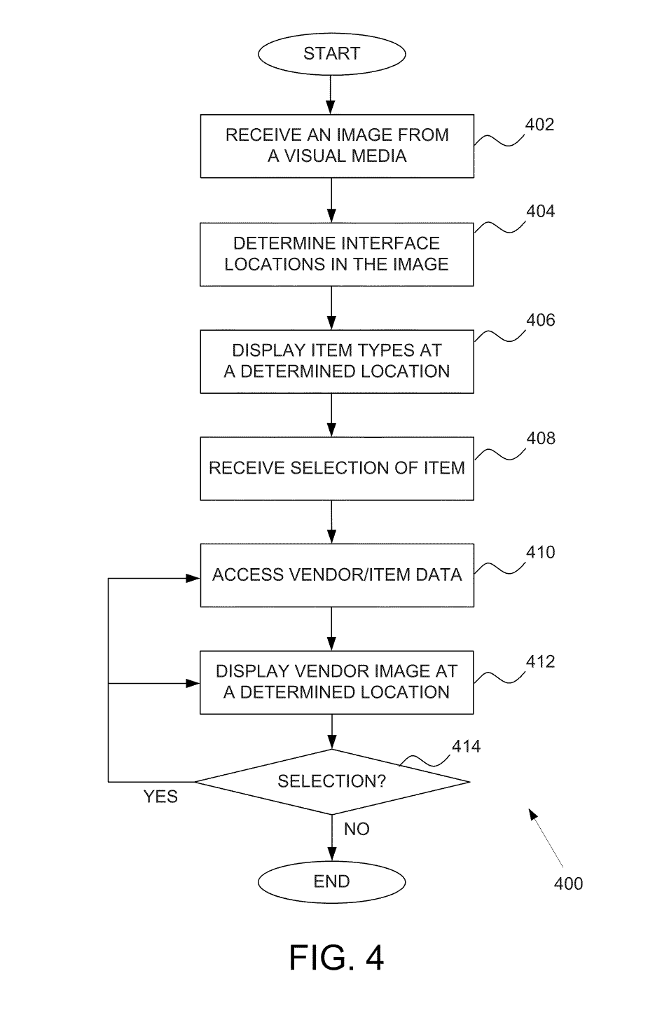

FIG. 4 is a flow diagram of an example high-level method 400 for using a smart wearable display device to interact with vendors integrated into a visual media image. In operation 402, an image from a visual media is received. In operation 404, designated interface locations in the image may be determined as described herein. In example embodiments, the imaging engine 212 may receive the visual media image from client device 110/wearable display device 113. The interface location may comprise multiple possible locations for integrating a shopping user interface into the visual media image.

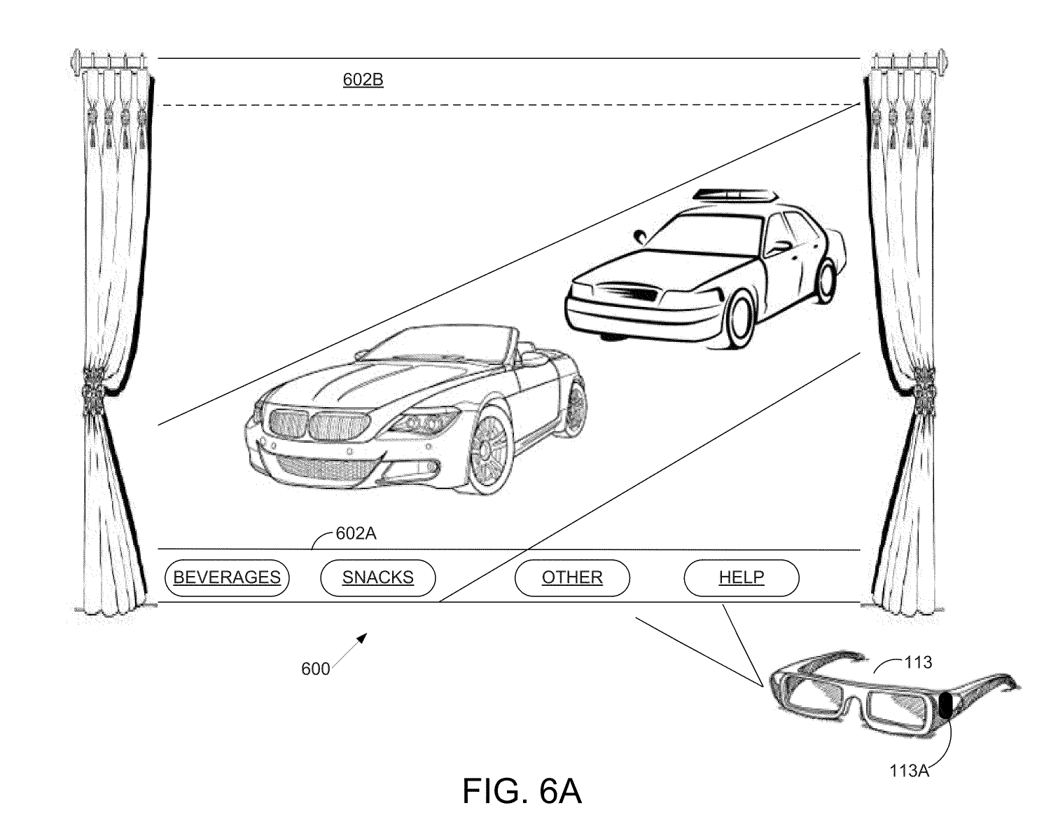

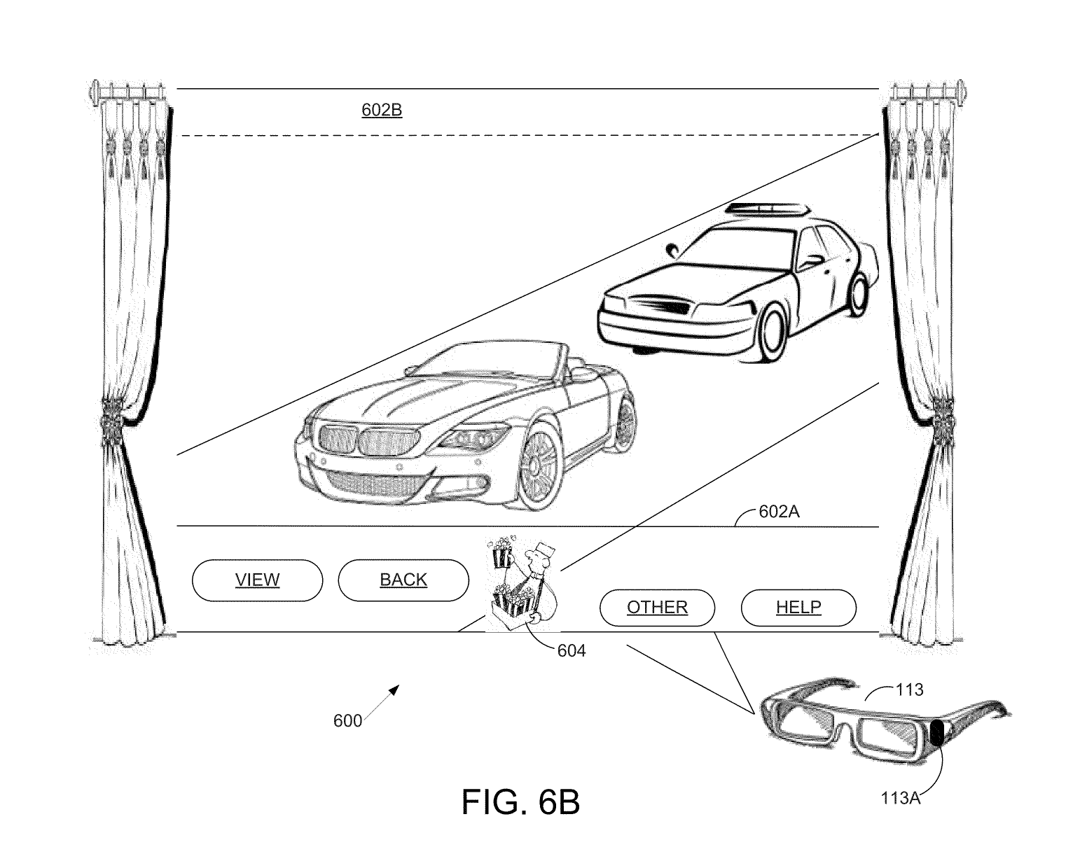

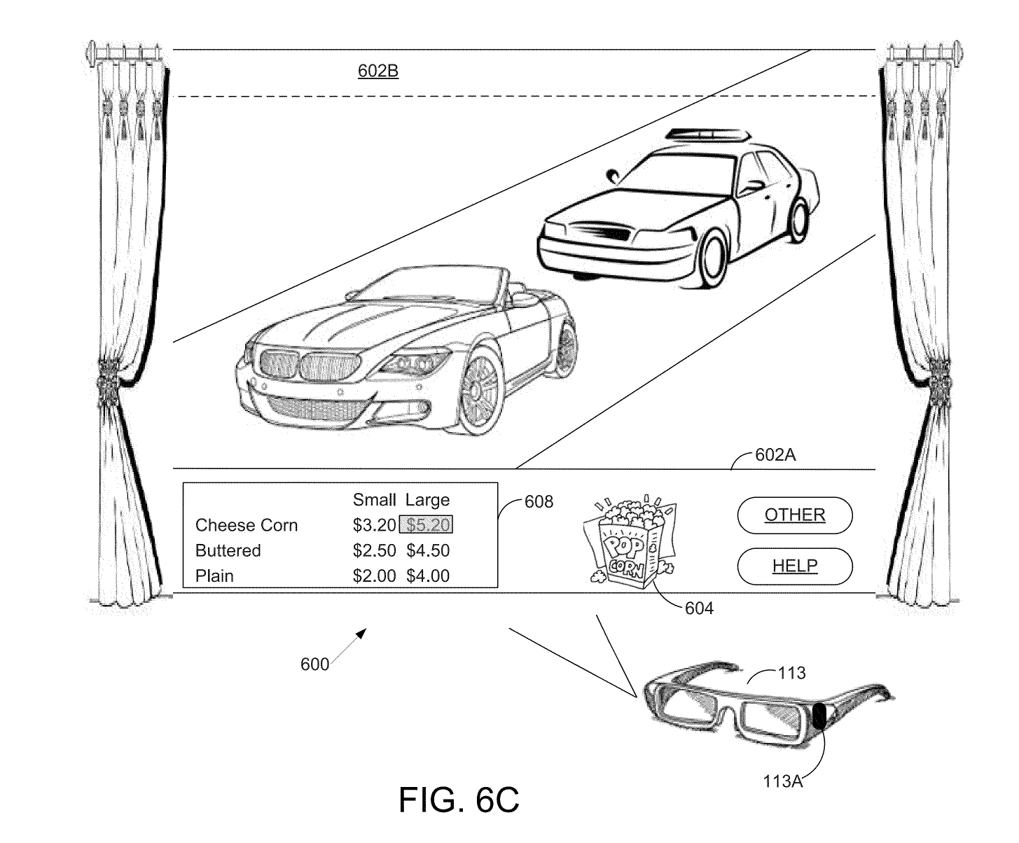

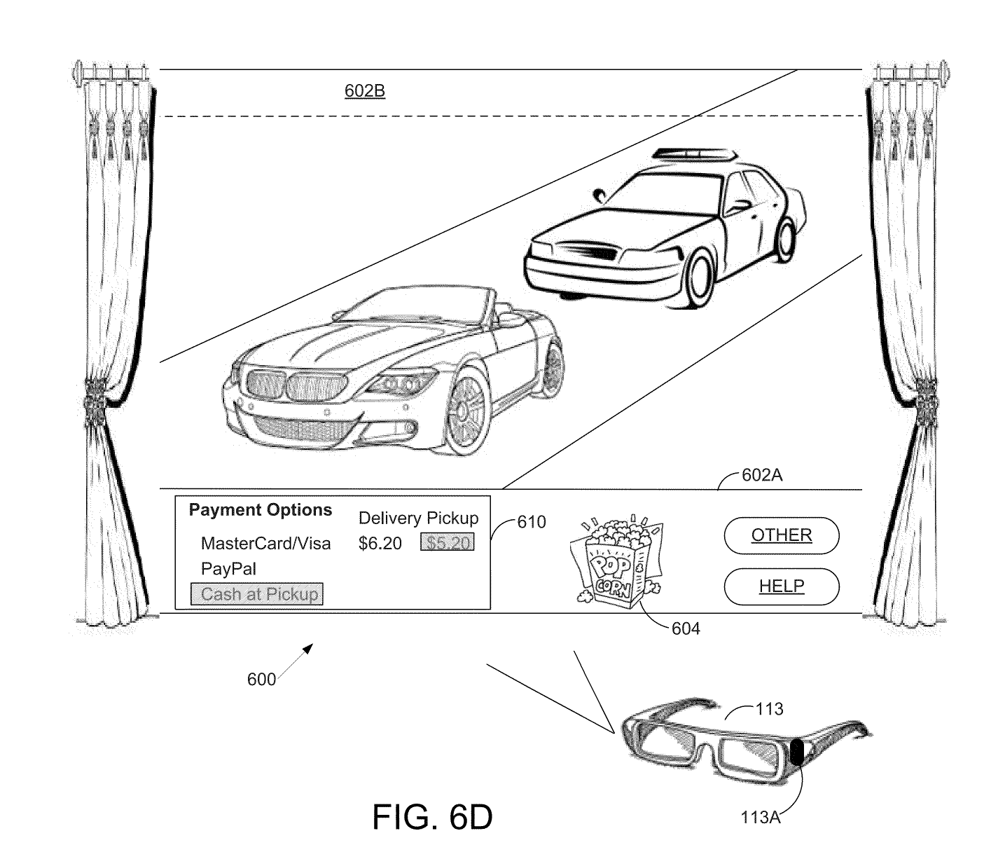

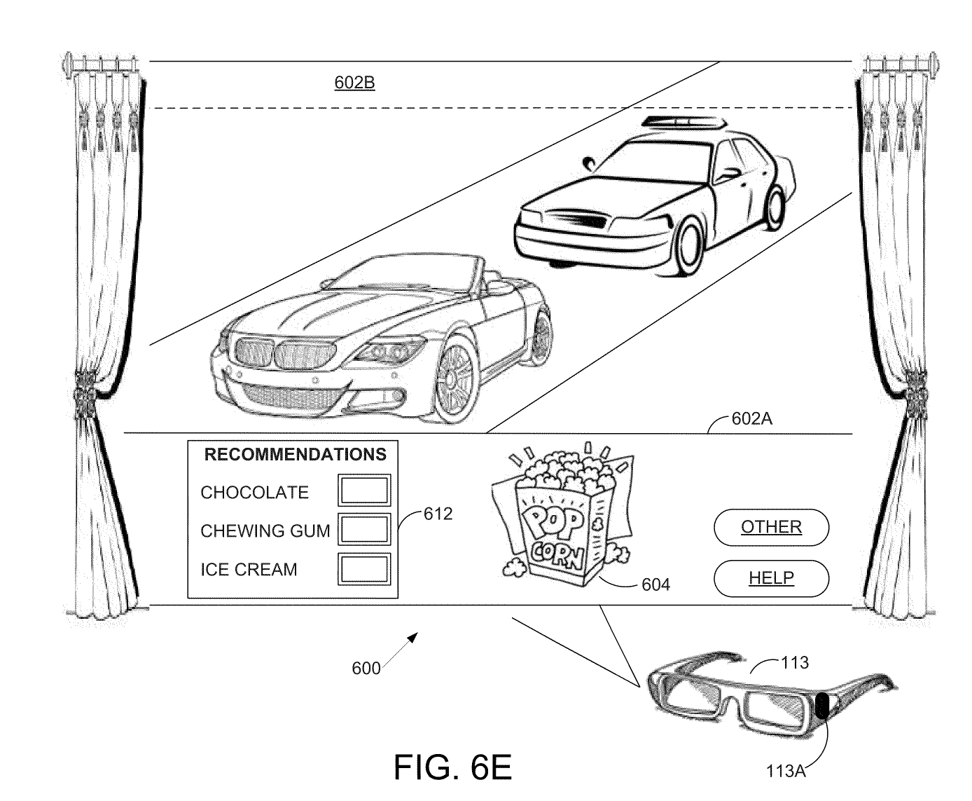

In operation 406, a user of 3D glasses 113 may select to view items for purchase via a shopping button 113 A (as shown in FIG. 6A). A plurality of item types for which vendors are available are displayed (e.g. on a display of 3D glasses 113) at the interface location e.g., one of the locations if several are possible. In other embodiments, the imaging engine 212 receives an image of an item that the user is interested in learning more about from the user himself who may capture the image using the 3D glasses 113.

In operation 408, a selection of an item type that the user is interested in learning more about is received. In some embodiments, the navigation engine 210 receives a selection of the item from the wearable display device 113 (e.g., smart 3D glasses), which may be coupled to client device 110.

Based on the received selection of the item type, vendor/item data is accessed in operation 410. The access module 300 accesses item data for vendors of the selected item type. The vendor/item data may be extracted from a vendor profile 220, an item listing for an item of the selected item type retrieved from an item catalog, or retrieved from a website of a manufacturer or reseller (e.g., using an item identifier of the item). The vendor/item data may be filtered according to specified criteria such as proximity to the user so that only vendors within a specified distance (e.g., to the lobby of a movie theater) are displayed.

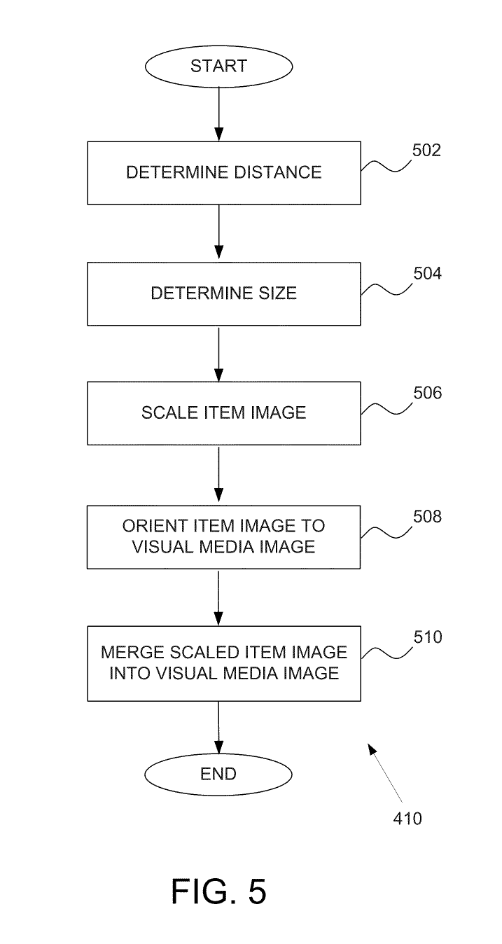

In operation 412, image integration processing is performed in order to display an image associated with a vendor (e.g., a vendor interface) at a determined interface location. Integration processing takes the visual media image and the selected item type and overlays an image of a vendor of the selected item type at a determined interface location in the visual media image based on the received image and/or any vendor image data received from imaging engine 212 or vendor profiles 220. In example embodiments, the integration module 310 provides the integrated image to the client device 110/wearable display device 113 of the user for display. The particular operations of the integration processing will be discussed in detail with respect to FIG. 5.

In operation 414, a determination is made as to whether a selection at the displayed vendor interface is received. In some embodiments, the selection may be received via a shopping button 113A of wearable display device 113. For example, if the shopping button 113A is used to select an item for purchase then the wearable display device 113 may display a payment interface for the vendor of the selected item. In another embodiment, the user may select an alternative item based on a recommendation provided by the recommendation module 312. Based on the nature of the selection, the method 400 may return to either operation 410 to access item data for the new item or to operation 412 to perform integration processing based on, for example, the payment interface for the vendor of the item selected for purchase.

FIG. 5 is a flow diagram of an example high-level method (corresponding to operation 410 of method 400 described above) for generating the integrated image including the image of a visual media and the integrated vendor image/interface. In operation 502, a distance is determined by the distance module 302. The distance module 302 determines a distance to a focal point in the visual media image. The focal point may an area where a vendor/item image is to be integrated. In one embodiment, the distance module 302 may use capabilities (e.g., focus, echo based on sound) of the wearable display device 113 (which may be coupled to client device 110) to determine the distance.

In operation 504, sizing for the visual media image is determined by the sizing module 304. In example embodiments, the sizing module 304 uses a marker in the visual media image to calculate the sizing. Using known standard dimensions of the marker, sizing of images to be integrated into the visual media may be determined by the sizing module 304.

The vendor/item image is scaled in operation 506. The scaling module 306 scales an image of the vendor/item based on the distance and sizing determined by the distance module 302 and the sizing module 304, respectively. Accordingly, the scaling module 306 may receive or retrieve the vendor/item data (e.g., from vendor profiles 220) including an item image, dimensions, or an item identifier. The retrieved item data is then used in association with the determined distance and sizing data to scale the vendor/item image.

Once the vendor/item image is scaled, the scaled vendor/item image may be oriented to the visual media image, in operation 508, by the orientation module 308. For example, if the visual media image includes a building that is at an angle with respect to the vertical direction and the scaled vendor/item image is to be overlaid on the visual media image near the image of the building, the orientation module 308 orients the scaled vendor/item image to the angle of the building.

In operation 510, the scaled and oriented item image is integrated or merged into the visual media image. The integration module 310 integrates the scaled and oriented vendor/item image with the visual media image at a designated interface location to create a visual media image with an integrated vendor interface for user interaction. It is noted that operations of FIG. 5 may be combined into fewer operations. Alternatively, some of the operations of FIG. 5 may be optional.

FIG. 6A is a screenshot of an example of a visual media image 600. The visual media image 600 may be a 3D image captured by wearable display device 113 (e.g., smart 3D glasses) or retrieved from a storage location (e.g., database 126) via a network connection. In the present example, the visual media image 600 is an image of a police car chase (e.g., from a 3D movie) into which a user wants to integrate interactive shopping interfaces for different types of items. In the present example, the visual media image 600 includes a designated interface location 602A for displaying interface options for item types that may be desired by a user at the location (e.g., movie theater). As explained herein, the presence of the designated interface locations maybe communicated to the wearable display device 113 via several options such as a code embedded in the visual media. Other optional interface location 602B is available; however in the present example location 602A has been determined as the current interface location. This determination may be based on, for example, a determination that interface location 602A is the least intrusive interface location (e.g., furthest from recognized objects in the image) for a shopping interface based on an analysis of the visual media image 600.

Therefore when a user of wearable display device 113 selects, via shopping button 113A, to browse the items available from local vendors, interface options are displayed at interface location 602A for user selection. For example, options for purchasing “beverages” and “snacks” may be displayed. Options for “other” types of items and for “help” with the interface options may also be displayed. If the user desires a snack, the shopping button 113A may be used to cycle through the options and select the “snacks” interface option.

FIG. 6B is a screenshot of the visual media image 600 with a 3D image 604 of a vendor of the item type “snack” selected by the user. In the present example, the 3D image 604 of the vendor comprises a vendor interface positioned at the interface location 602A for user selection. In one embodiment, additional information regarding the merchandise of the vendor associated with 3D image 604 may be obtained by selecting the “view” interface option. Selection of the “back” interface option will return the user to the previous interface options as illustrated in FIG. 6A. For example, the user may select the “view” interface option to view purchase information (e.g., a listing for the item, prices, options, where else to buy, links to online stores, etc.), item information (e.g., dimensions, description), alternative recommendations (e.g., smaller or larger items, comparable items, less expensive items, newer version of the item), or any combination of these in regard to products offered by the vendor associated with the vendor associated with 3D image 604.

FIG. 6C illustrates an example 3D image 606 of popcorn including a popcorn menu window 608 for displaying shopping information pertaining to the selected item. The 3D image 606 of popcorn is provided when the user makes a selects to “view” the snack vendor's items in order to entice the user with the image of delicious popcorn or some other tasty snack. In the present example, the popcorn menu window 608 provides shopping information including a flavors, sizes and prices for the popcorn available from the snack vendor, each comprising links selectable by the user for purchasing items from the vendor. In the present example, the user has decided to splurge on large cheese corn popcorn as indicated by the highlighted price: “$5.20”.

FIG. 6D illustrates an example payment options window 610 associated with the user selection of large cheese corn popcorn. The payment options window 610 may display several options for electronically paying (e.g., credit card, PayPal) or paying by cash when picking up the popcorn in the lobby of the movie theater. The user may also select to pick up the popcorn or have the popcorn delivered to their seat, which may be associated with the wearable display device 113. In the present example, since the user purchased the more expensive large cheese corn popcorn, the user has now selected (shown highlighted) to save some money and exercise a little by picking up the popcorn in the lobby for no extra charge. Any other payment processing or payment information pertaining to the selected item may be provided in the payment options window 610.

FIG. 6E illustrates an example recommendations window 612 for displaying snack recommendations to the user of 3D glasses 113. The recommendations may be provided by the recommendation module 312 and include a name of each recommended item and/or an image (e.g., 3D image) of the recommended item. Other information, such as price, ratings, or dimensions, may also be provided in the recommendations window 612. The recommendations may be, for example, items that other users interested in popcorn have also been interested in, items that are similar but less expensive than a selected item, items that are a newer model than a selected item, or items that rank higher based on reviews by other users of the system.

While the various examples of FIG. 6C-6E show provide windows for displaying additional information, alternative embodiments may use other display mechanisms to provide the additional information. For example, the additional information may be displayed on a side of a display showing the 3D media environment image 600.

### Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Example Machine Architecture and Machine-Readable Medium

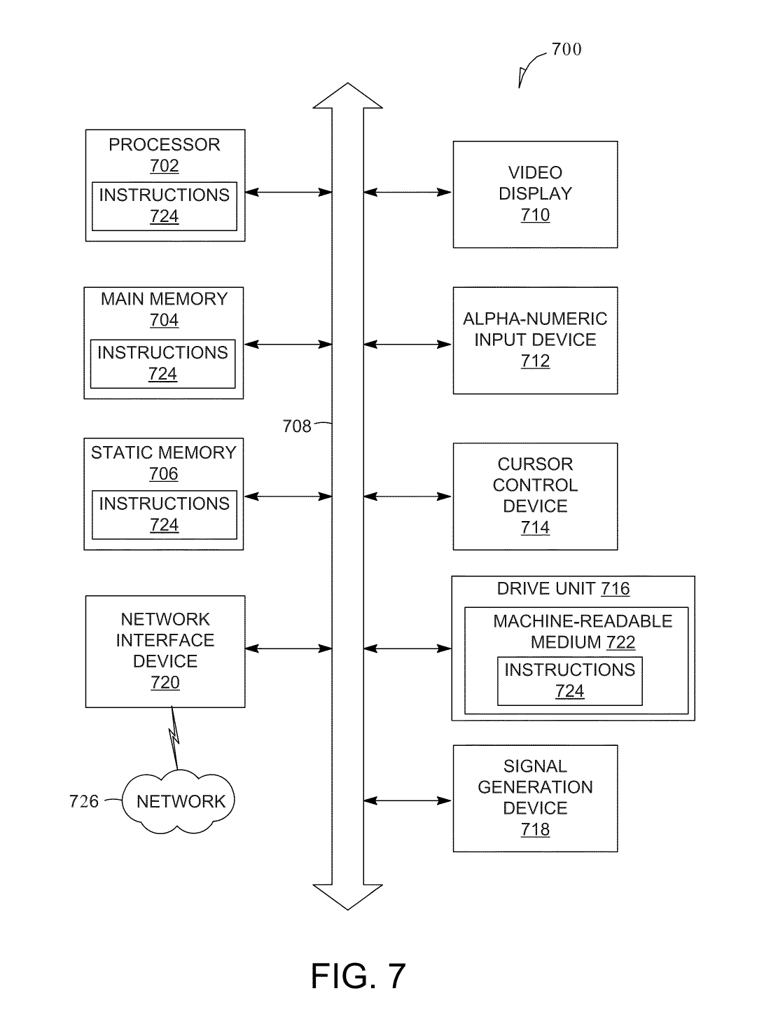

With reference to FIG. 7, an example embodiment extends to a machine in the example form of a computer system 700 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 may include a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). In example embodiments, the computer system 700 also includes one or more of an alpha-numeric input device 712 (e.g., a keyboard), a user interface (UI) navigation device or cursor control device 714 (e.g., a mouse), a disk drive unit 716, a signal generation device 718 (e.g., speaker), and a network interface device 720.

### Machine-Readable Storage Medium

The disk drive unit 716 includes a machine-readable storage medium 722 on which is stored one or more sets of instructions 724 and data structures (e.g., software instructions) embodying or used by any one or more of the methodologies or functions described herein. The instructions 724 may also reside, completely or at least partially, within the main memory 704 or within the processor 702 during execution thereof by the computer system 700, with the main memory 704 and the processor 702 also constituting machine-readable media.

While the machine-readable storage medium 722 is shown in an example embodiment to be a single medium, the term “machine-readable storage medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other medium to facilitate exchange of software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

### Example Mobile Device

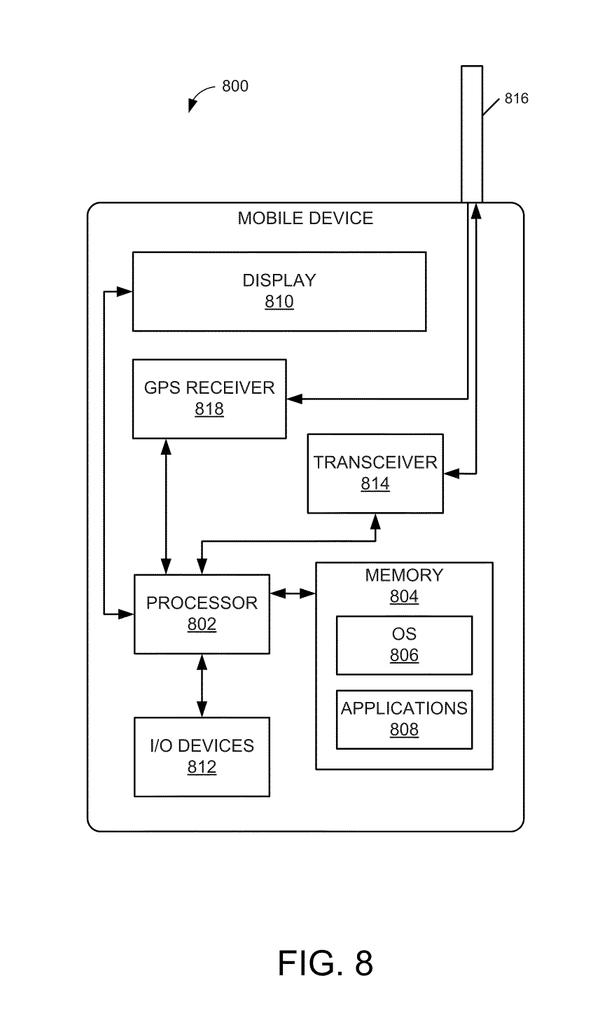

FIG. 8 is a block diagram illustrating a mobile device 800, according to an example embodiment. The mobile device 800 can include a processor 802. The processor 802 can be any of a variety of different types of commercially available processors suitable for mobile devices (for example, an XScale architecture microprocessor, a Microprocessor without Interlocked Pipeline Stages (MIPS) architecture processor, or another type of processor). A memory 804, such as a Random Access Memory (RAM), a Flash memory, or another type of memory, can be accessible to the processor. The memory 804 can be adapted to store an operating system (OS) 806, as well as application programs 808, such as a mobile location enabled application that can provide LBSs to a user.

The processor 802 can be coupled, either directly or via appropriate intermediary hardware, to a display 810 and to one or more input/output (I/O) devices 812, such as a keypad, a touch panel sensor, a microphone, and the like. Similarly, in some embodiments, the processor 802 can be coupled to a transceiver 814 that interfaces with an antenna 816. The transceiver 814 can be configured to both transmit and receive cellular network signals, wireless data signals, or other types of signals via the antenna 816, depending on the nature of the mobile device 800. Further, in some configurations, a GPS receiver 818 can also make use of the antenna 816 to receive GPS signals.

1. A system comprising:
a wearable display device including:
at least one lens;
at least one projector to project images onto the at least one lens;
at least one user input interface; and
a vendor interaction engine including:
at least one processor;
an image module configured to receive an image from a visual media being viewed through the at least one lens and an indication of at least one designated interaction location in the image;
a vendor type module configured to:
in response to a user input via the user input interface, display a plurality of interface objects on the at least one lens so that the user sees them overlaid at one of the at least one interaction locations; and
receive a user selection of an interface object representing a type of product via the user input interface; and
a vendor display module configured to display, on the at least one lens, an image associated with a vendor of the product type so that the user sees it overlaid at one of the at least one interaction locations.

2. The system of claim 1, further comprising a scaling module configured to scale the image associated with the vendor based on dimensional information extracted from the received image.

3. The system of claim 1, wherein the wearable display device further comprises a camera to receive the image from the visual media and the indication is received by the image module reading a code embedded in the image or the image and the indication are received separately by the wearable display device via a network connection.

4. The system of claim 1, wherein the displayed product types are associated with products sold by vendors that are located in the vicinity of the user.

5. The system of claim 4, wherein:
the vendor image display module is further configured to:
in response to a user input via the user input interface, display a plurality of vendor interface objects associated with the vendor;
receive a user selection of a vendor interface object representing a specific product sold by the vendor via the user input interface; and
display additional information for the specific product;
wherein the additional information comprises at least one of: shopping information, product description information, links to shopping sites, links to product listings, pricing information, delivery information or product recommendation information.

6. The system of claim 5, wherein the vendor display module is further configured to display a respective purchase button associated with each of the interface objects representing specific products sold by the vendor, activation of the purchase button resulting in a purchase of the respective specific product from the vendor.

7. The method of claim 6, wherein the visual media comprises a 3D movie, the wearable display device comprises 3D glasses and the purchased product is delivered to a seat in a movie theater associated with the 3D glasses.

8. A method comprising:
receiving an image from a visual media being viewed by a user through at least one lens of a wearable display device, the image including an embedded code designating at least one interaction location in the image;
reading the code to discover the least one interaction location in the image;
in response to input from the user, displaying a plurality of interface objects on the at least one lens so that the user sees them overlaid at one of the at least one interaction locations; and
receiving a user selection of an interface object representing a type of product; and
displaying, on the at least one lens, an image associated with a vendor of the product type so that the user sees it overlaid at one of the at least one interaction locations.

9. The method of claim 8, further comprising scaling the image associated with the vendor based on dimensional information extracted from the received image.

10. The method of claim 8, wherein the displayed product types are associated with products sold by vendors that are located in the vicinity of the user.

11. The method of claim 10, further comprising:
in response to user input, displaying a plurality of vendor interface objects associated with the vendor;
receiving a user selection of a vendor interface object representing a specific product sold by the vendor; and
displaying additional information for the specific product.

12. The method of claim 11, wherein the additional information comprises at least one of: shopping information, product description information, links to shopping sites, links to product listings, pricing information, delivery information or product recommendation information.

13. The method of claim 12, further comprising:
displaying a respective purchase button associated with each of the interface objects representing specific products sold by the vendor,
in response to an activation of the purchase button, processing a purchase transaction between the user and the vendor in regard to the respective specific product.

14. The method of claim 13, wherein the visual media comprises a 3D movie and the wearable display device comprises 3D glasses, the method further comprising delivering the purchased product to a seat in a movie theater associated with the 3D glasses.

15. A non-transitory machine-readable medium storing instructions which, when executed by the at least one processor of a wearable display device, causes the device to perform operations comprising:
receiving an image from a visual media being viewed by a user through at least one lens of a wearable display device, the image including an embedded code designating at least one interaction location in the image;
reading the code to discover the least one interaction location in the image;
in response to input from the user, displaying a plurality of interface objects on the at least one lens so that the user sees them overlaid at one of the at least one interaction locations; and
receiving a user selection of an interface object representing a type of product; and
displaying, on the at least one lens, an image associated with a vendor of the product type so that the user sees it overlaid at one of the at least one interaction locations.

16. The non-transitory machine-readable medium of claim 15, the operations further comprising scaling the image associated with the vendor based on dimensional information extracted from the received image data.

17. The non-transitory machine-readable medium of claim 15, wherein the displayed product types are associated with products sold by vendors that are located in the vicinity of the user.

18. The method of claim 17, further comprising:
in response to user input, displaying a plurality of vendor interface objects associated with the vendor;
receiving a user selection of a vendor interface object representing a specific product sold by the vendor; and
displaying additional information for the specific product;
wherein the additional information comprises at least one of: shopping information, product description information, links to shopping sites, links to product listings, pricing information, delivery information or product recommendation information.

19. The non-transitory machine-readable medium of claim 18, the operations further comprising:
displaying a respective purchase button associated with each of the interface objects representing specific products sold by the vendor,
in response to an activation of the purchase button, processing a purchase transaction between the user and the vendor in regard to the respective specific product.

20. The non-transitory machine-readable medium of claim 15, wherein the visual media comprises a 3D movie and the wearable display device comprises 3D glasses, the method further comprising delivering the purchased product to a seat in a movie theater associated with the 3D glasses.
